(19) United States
(12) Patent Application Publication
(10) Pub. No.: US 2013/0022510 A1
(43) Pub. Date: Jan. 24, 2013

(54) MEMBRANE STRUCTURES SUITABLE FOR GAS SEPARATION, AND RELATED PROCESSES

(71) Applicant: General Electric Company, Schenectady, NY (US)

(72) Inventors: Hrishikesh Keshavan, Clifton Park, NY (US); Anthony Yu-Chung Ku, Rexford, NY (US); Steven Mitchell Kuznicki, Alberta (CA); An Weizhu, Alberta (CA)

(73) Assignee: GENERAL ELECTRIC COMPANY, Schenectady, NY (US)

(21) Appl. No.: 13/630,807

(22) Filed: Sep. 28, 2012

Related U.S. Application Data
(63) Continuation-in-part of application No. 12/957,151, filed on Nov. 30, 2010.

(51) Int. Cl. B01D 69/12; B01D 67/00; B01J 7/02; B01D 53/22; B01D 53/02

(52) U.S. Cl. 422/162; 95/55; 96/12; 96/11; 427/244

(57) ABSTRACT

A method for fabricating a high-density zeolite membrane structure is described. The method includes the step of combining (i) a mineral zeolite material; (ii) at least one cement precursor; and (iii) an organic binder, with an aqueous component, to form an aqueous composite zeolite composition. The zeolite composition is then applied on a surface of a scaffold formed from a porous, metal oxide material. The zeolite composition is dried, and then heated under conditions to form a metal oxide-zeolite composite layer. This layer is exposed to a phosphate composition, under conditions sufficient to reduce the porosity to a level no greater than about 10%. A high-density zeolite cement composite membrane structure results. Related methods for separating hydrogen from a fluid stream, using the membrane structure, are also disclosed.

This application is a Continuation-in-Part of application Ser. No. 12/957,151 (K. McEvoy et al), filed on Nov. 30, 2010, the contents of which are incorporated herein by reference.

This invention generally relates to the selective separation of one or more gases from a gas stream. In some specific embodiments, the invention relates to membrane structures used in the preferential separation of hydrogen or other gases that are often components of a gas stream resulting from various combustion or gasification systems.

Membranes are selectively permeable barriers that can be used to separate gases. One exemplary application for membranes is to separate gases in power generation, specifically integrated gasification combined cycle (IGCC) power plants. These power plants generate electricity from carbonaceous fuel such as coal, petcoke, or biomass, through a series of steps, including gasification of the solid fuel to form a mixture of hydrogen (H₂), carbon monoxide (CO), carbon dioxide (CO₂), water vapor, and trace impurities. The mixture is commonly known as “synthesis gas” or “syngas”. Impurities are removed from the syngas mixture, through a series of clean-up operations. The cleaned gas is then combusted to produce electricity in a combined cycle.

IGCC plants offer advantages in efficiency because the clean-up of impurities is performed on high pressure gas streams before combustion. Membranes can be used in the IGCC clean-up process to separate the syngas into a fuel-rich stream that can be used to generate electricity, and a CO₂-rich retentate stream to enable “carbon capture”. The use of a membrane for carbon capture can involve the selective permeation of CO₂ through the membrane, separating it from the rest of the gas stream, or can involve the selective permeation of hydrogen, the primary fuel gas. In an ideal situation for some power generation systems, gas separation is carried out at high temperature and pressure, so as to minimize the necessity for compressing the CO₂ prior to sequestration. In some cases, hydrogen-selectivity (as compared to CO₂ selectivity) is a key parameter in a gas separation system.

Many types of membrane structures are available for gas separation at relatively high temperatures. Most are based on metallic or ceramic materials. While dense metallic membranes are useful for some gas separation processes, they are also deficient in some respects. For example, the metals in such membranes are often intolerant of sulfur. Therefore, in separating gas mixtures which may include compounds like hydrogen sulfide (e.g., gas streams produced from sulfur containing feedstocks such as low rank coal, petcoke, or biomass), metallic membranes can suffer irreversible degradation.

Moreover, some of the membrane materials currently in use can be very expensive, as can the techniques that are needed to process and package the membranes. As an example, high-purity, synthetic zeolite materials, often used in the catalyst industry, can be costly to produce—especially on a large-scale commercial basis. Furthermore, in high-temperature areas, like gasification and combustion, membranes used in gas separation must be durable enough to function successfully in very hostile environments. Temperature, pressure, and the presence of acidic gases can severely damage many types of membranes.

Moreover, since gas separation with membranes is most often a size-based process, the membranes need to have pore size characteristics (e.g., “cage size”) that can differentiate gas molecules of different sizes. For example, a separation process will usually not succeed if a membrane has a cage size that is large enough to allow the passage of molecules of two gases that require separation from each other. Modification of the pore size for a given membrane material to accommodate gas molecules of varying size can be an expensive, impractical undertaking.

In view of the various objectives and concerns noted above, new techniques for preparing very dense membrane structures would be welcome in the art. The techniques should allow for the efficient production of structures, using relatively inexpensive starting materials. Moreover, the resulting membranes should exhibit good hydrogen selectivity. The membranes should also be relatively tolerant of harmful gases like hydrogen sulfide, and in general, should be suitable for use in corrosive atmospheres. Furthermore, the membranes should be compatible with a variety of power generation and gasification systems that utilise fossil fuels, or biomass, and should also be suitable for other industrial processes related to hydrogen separation and use.

### SUMMARY OF THE INVENTION

An embodiment of the invention is directed to a method for fabricating a high-density zeolite membrane structure. The method comprises the following steps:

a) combining (i) a mineral zeolite material; (ii) at least one cement precursor; and (iii) an organic binder, with an aqueous component, to form an aqueous composite zeolite composition;

b) applying a porous layer of the aqueous composite zeolite composition to a first surface of a scaffold comprising a porous, metal-oxide material;

c) allowing the porous layer to dry at an evaporation rate slow enough to substantially prevent the formation of coating cracks; under conditions of relatively high humidity;

d) heating the dried coating at a temperature in the range of about 150° C. to about 750° C., for a time period sufficient to substantially remove the organic binder; resulting in the formation of a metal oxide-zeolite composite layer; and e) exposing the metal oxide-zeolite composite layer to a phosphate composition, under conditions sufficient to reduce the porosity in the composite layer to a level of no greater than about 10%, resulting in a high-density zeolite cement composite membrane structure.

Another embodiment of the invention is directed to a method for separating hydrogen from a fluid stream. The method comprises the step of contacting the fluid stream with at least one membrane structure, to preferentially transport hydrogen across the structure, wherein the membrane structure comprises a high-density zeolite phosphate-cement composite structure.

Still another embodiment is directed to a composite membrane. The membrane comprises a percolating, zeolite structure, interspersed within a continuous, phosphate-based cement matrix, and disposed on a porous metal oxide support structure.

### DRAWINGS

FIG. 1 is a schematic, cross-sectional representation of a membrane structure according to embodiments of the present invention.

FIG. 2 is an end-perspective view of a membrane module, according to embodiments of this invention.

FIG. 3 is a representation of a gas separation module, according to embodiments of this invention.

FIG. 4 depicts another membrane module, according to some embodiments of the invention.

FIGS. 5A-5C are photomicrographs depicting aspects of the preparation of a composite membrane according to embodiments of the present invention.

FIG. 6 is an SEM image of a composite coating structure applied on a scaffold substrate, according to embodiments of this invention.

### DETAILED DESCRIPTION

Any compositional ranges disclosed herein are inclusive and combinable (e.g., ranges of “up to about 25 wt %”, or, more specifically, “about 5 wt % to about 20 wt %”, are inclusive of the endpoints and all intermediate values of the ranges). Weight levels are provided on the basis of the weight of the entire composition, unless otherwise specified; and ratios are also provided on a weight basis. Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items.

The modifier “about” used in connection with a quantity is inclusive of the stated value, and has the meaning dictated by context, (e.g., includes the degree of error associated with measurement of the particular quantity). The suffix “(s)” as used herein is intended to include both the singular and the plural of the term that it modifies, thereby including one or more of that term (e.g., “the refractory element(s)” may include one or more refractory elements). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

The mineral used for the membrane structure can comprise various zeolite materials. In preferred embodiments, the materials are naturally occurring, i.e., as distinguished from synthetic zeolite materials. Examples of the zeolite materials include clinoptilolite, heulandite, and mordenite. Combinations of these materials can be used as well. Each of these types of zeolite materials are known in the art. The mordenite materials, for example, are generally orthorhombic, and have the chemical formula (A) Al₂Si₁₀O₂₄.7H₂O, wherein “A” represents one or more cations, such as Na⁺, K⁺, Ca⁺², Mg⁺², or combinations thereof. The heulandite materials are sometimes referred to as “tecto-silicates”, and usually have a common structure, with different cations, such as calcium, sodium, potassium, strontium, and barium. One very common heulandite is the calcium (hydrous) version, (Ca,Na)₂₋₃Al₃(Al,Si)₂Si₁₃O₃₆.12H₂O.

As described in U.S. Patent Publication 2012/0135215 (McEvoy et al; based on application Ser. No. 12/957,151, and incorporated herein by reference), the heulandite and clinoptilolite mineral species can be distinguished on the basis of the silicon/aluminum ratio (Si/Al) in the zeolite framework. The heulandite species has a Si/Al ratio of less than 4.0, while the clinoptilolite species has a ratio of 4.0 or greater. (In some instances, the clinoptilolite species and the heulandite species are considered as both belonging to a broader genus which also happens to be referred to as “heulandite”).

The clinoptilolite materials are often preferred, in terms of cost, availability, thermal stability, and natural “cage size”, as further described below. Clinoptilolite is a natural zeolite, and usually comprises a microporous arrangement of silica and alumina tetrahedra. Clinoptilolite materials have the formula (Na,K,Ca)₂₋₃Al₃(Al,Si)₂Si₁₃O₃₆.12H₂O. The material is often in the form of white or reddish tabular monoclinic tectosilicate crystals. The crystals often have a Mohs hardness of about 3.5-4; and a specific gravity of about 2.1 to 2.2. In general, the zeolite materials have an average particle size of up to about 45 microns. In some preferred embodiments, the average particle size is in the range of about 0.3 micron to about 10 microns. (It should also be noted that in some situations, naturally-occurring mordenite may be preferred for use in the membrane structure, in view of its own, relatively high thermal stability).

As mentioned above, the mineral zeolite material is combined with at least one cement precursor material. As those skilled in the art understand, “cement” usually comprises some form of an inorganic binder material. Various types of cement may be suitable for embodiments of this process. Some of the hydraulic-types (“hydrated” types) of cement may be used, although Portland cement has been shown to be ineffective in some embodiments. Non-silicate-based cements are often preferred, such as aluminate cements (e.g., calcium aluminate) and phosphate cements.

Most often, the cement is provided in the form of a powder or liquid-based precursor system. When the constituents in the precursor system are combined, a paste is formed. The paste can undergo partial dissolution, initiating a precipitation reaction that “sets” the cement.

The cement precursor material often comprises at least one metal oxide. In some preferred embodiments, the metal oxide component comprises magnesium oxide. Magnesium oxide can support a number of bonding phases that are desirable in hardened cement pastes. However, in other embodiments, other oxides that react to some degree with phosphates can be employed. Non-limiting examples include calcium oxide, aluminum oxide (alumina), and zinc oxide.

It is usually important to control the amount of the metal oxide (such as magnesium oxide), relative to the other components in the cement. In some embodiments, the level of metal oxide should be about 1% by weight to about 30% by weight, based on the weight of the zeolite material being used. However, the range may vary to some degree, depending, in part, on the particular metal oxide that is being used.

In some embodiments, it is very desirable that powder particles of the metal oxide component in the cement, such as magnesium oxide, have a relatively small surface area. The reduced surface area can lower the overall reactivity of the metal oxide, which is advantageous in most circumstances. The material used is often referred to as “dead burned”, which usually results from calcining at about 1500° C. to about 2000° C., to produce a refractory grade in which substantially all reactivity has been eliminated. Thus, the powder particles of the metal oxide preferably have an average surface area of less than about 1 m²/g, and in some instances, less than about 0.5 m²/g, as measured by BET.

The general ratio between the zeolite component and the cement precursor can also be significant for embodiments of this invention. Some of the factors which influence the selection of an appropriate ratio include the specific type of zeolite and cement components; and the type of hydration chemistry which will be present when the components are combined. Usually, the ratio of zeolite to cement precursor will be in the range from about 1:1 to about 20:1. In some preferred embodiments, e.g., wherein the zeolite comprises clinoptilolite; and the cement precursor comprises magnesium oxide, a preferred ratio may be in the range of about 2:1 to about 20:1.

As mentioned above, the composite composition also contains at least one organic binder material. Various materials can be used; and some (though not all) are water-soluble synthetic polymers. Non-limiting examples include ethylene-vinyl-chloride (EVCl), poly-vinylidene-chloride (PVdC), modified poly-vinyl-chloride (PVC), polyvinyl-alcohol (PVOH), polyethylene glycol (PEG), polyvinyl-pyrrolidone, polyethylene-vinyl-acetate (EVA), and poly-vinyl-acetate (PVA). In some preferred embodiments, the organic binder is polyvinyl-alcohol (PVA), which offers excellent adhesion to porous, water-absorbent surfaces. The amount of binder needed will depend on a number of factors, but is usually about 5% to about 50%, based on the total solids-weight of the composite composition.

Usually, the zeolite composition that contains the binder and cement precursor is combined with one or more aqueous solvents to form an aqueous mixture. The use of an aqueous system comprising mainly water is preferred in many instances, since the water constituent is effective in stabilising the coating particles by controlling surface charging.

A layer of the zeolite composition is then applied to a substrate or “scaffold” that itself comprises a porous, metal-oxide (i.e., “inorganic”) material. One surface of the scaffold (i.e., a “first surface”) serves as a platform for the composition, as discussed below. A number of techniques can be used to apply the zeolite composition to the scaffold. Non-limiting examples include pouring, painting, dipping, spraying, tape-casting, and screen-printing. The material can be applied in one layer, although multiple layers may also be possible.

The thickness of the applied layer of the zeolite composition will depend on various factors. They include: the specific type of zeolite membrane; its liquid content (e.g., the types of solvents); the shape of the scaffold; the type of subsequent process steps to be employed; and the required density or permeability of the membrane structure. Usually, the amount of material that is applied is sufficient to provide a cured membrane structure with a thickness between about 2 microns and about 100 microns, and preferably, between about 5 microns and about 50 microns.

The shape of the scaffold can vary, depending on the intended end use of the membrane structure. It can be in the form of a disc, a square or rectangular plate, a tube, or any honeycomb structure, for example. Moreover, the scaffold can usually be formed of a variety of materials, e.g., metal, ceramic, cermet, and in some instances, high-temperature polymers. The selected material should exhibit mechanical integrity in the environment in which the membrane will be used, and should be capable of being formed into a porous structure. The material should also be capable of withstanding coating processing temperatures of at least about 260° C., i.e., the temperature used to burn out the binder material from the zeolite. (Thus, other binder materials might require scaffold materials with higher thermal resistance, e.g., at least about 400° C.). Non-limiting, specific examples of the scaffold materials include aluminum oxide (alumina), silica, zirconia, magnesium oxide, yttria, titania, mullite, cordierite, steel, and combinations thereof.

In many embodiments, the scaffold is generally tubular in shape. A resulting membrane structure in the shape of a tube can be very advantageous in some instances. A tubular structure can be structurally robust, and very durable under high gas pressures. Moreover, the tube (or a series of tubes, as described below) exhibits efficient flow characteristics. In other words, the tubular structure can readily accommodate the flow of gaseous product mixtures in an industrial setting, e.g., through and between various units in a power plant. Furthermore, tubes formed of aluminum oxide or other suitable materials are readily available on a commercial basis, in a wide variety of lengths, diameters, wall thicknesses, porosity grades, and the like.

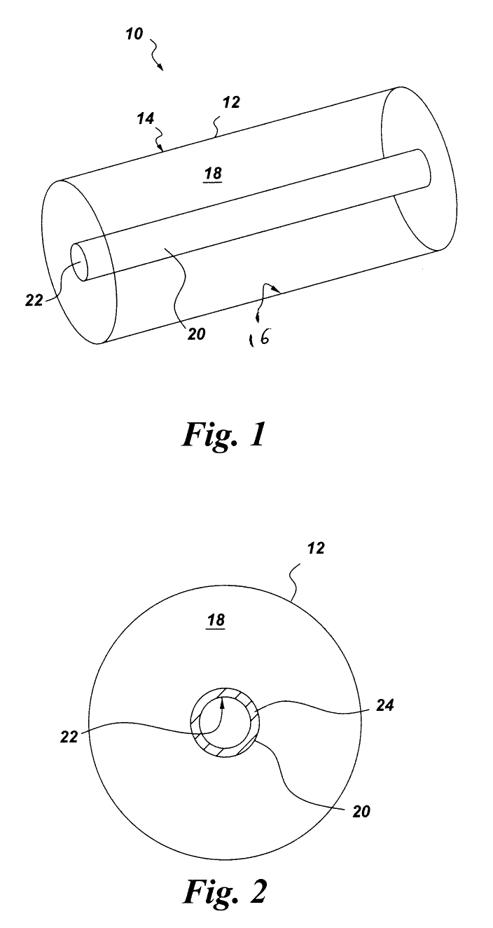

FIG. 1 is a side-perspective view of a gas separation module 10 made by various embodiments of the present invention, and suitable for different types of gas separation. (Some details of the structure are omitted in this particular figure, for simplicity). Module 10 includes a housing 12, which can be made from a number of materials, such as stainless steel. In this embodiment, the housing is generally tubular, and includes an outer surface 14, and an inner surface 16. A cavity 18 is formed within the housing. In this embodiment, the outer surface 14 has a circular, cross-sectional shape, with each side having approximately the same length. However, many other shapes are possible, e.g., hexagonal.

The housing 12 contains a membrane structure 20, which is sometimes referred to as a “membrane support structure”. Structure 20 comprises the porous scaffold discussed previously. The membrane structure can be sealed within the housing by various means, e.g., using polymeric gaskets, with a choice of specific materials to fit special needs. It should be emphasized that while one membrane structure is depicted in the drawing, the housing 12 can accommodate a number of membrane structures, each of which can provide the desired gas separation functionality, as described below. In the case of tubes, each structure would usually be spaced from the other structures, and would be concentric through the length of the housing. (See, for example, the general arrangement of multiple membrane structures depicted in FIG. 4 of U.S. Patent Publication 2011/0030382, G. Eadon, A. Ku, and V. Ramaswamy, incorporated herein by reference). In preferred embodiments, the inside surface 22 of the membrane structure is provided with the layer of the porous zeolite composition (not shown in FIG. 1), as discussed below.

After the aqueous zeolite composition is applied to surface of the membrane structure (the first surface of the scaffold), the porous coating material is allowed to dry. The drying technique can be important for ensuring the integrity and overall quality of the coating. The aqueous nature of the coating in most embodiments can result in coating cracks, which would detract from coating quality.

In general, the coating material is preferably dried under conditions of relatively high humidity, e.g., at least about 75%, and preferably, at least about 85%, and at temperatures in the range of about 20° C. to about 80° C. The overall evaporation rate for drying is slow enough to substantially prevent the formation of coating cracks. In the case of a clinoptilolite-based coating having a “wet thickness” of about 40-60 microns, deposited on an alumina substrate, the drying time usually ranges from about 8 hours to about 100 hours.

In a typical embodiment, the dried coating still includes organic binder materials, which have to be removed. In some preferred embodiments, the coating is heated under conditions sufficient to remove substantially all of the organic material. The “de-binding” step is usually carried out at a temperature in the range of about 150° C. to about 750° C., for a time period between about 1 hour and about 10 hours.

The specific de-binding temperature will depend in part on factors like coating thickness, the type of zeolite material used, and the type of organic binder(s) employed. In some specific embodiments, the temperature is in the range of about 250° C. to about 550° C. In general, longer heating times will compensate for lower heating temperatures, within the ranges described above; while higher heating temperatures will compensate for shorter heating times. The heating step is usually carried out in a furnace, in an air atmosphere. An inorganic layer is thus formed, i.e., a metal oxide-zeolite composite layer.

The metal oxide-zeolite composite layer is then exposed to a phosphate composition, e.g., a composition containing one or more suitable phosphate compounds. The phosphate composition reacts with the metal oxide in the composite, to form the corresponding metallic phosphate or “cement”. In forming the phosphate compound, a substantial amount of the porosity is removed from the composite layer, resulting in a high-density zeolite composite membrane structure. As one example, the magnesium oxide in a zeolite composite will be converted to magnesium phosphate. In the case of calcium oxide, the resulting composite will comprise calcium phosphate.

A number of phosphate compounds may be suitable, as long as they are capable of reacting with the particular metal oxide in the composite. A salt-form of the phosphate is usually employed. Non-limiting examples include ammonium phosphate, diammonium phosphate, monoammonium phosphate, monopotassium phosphate, sodium phosphate, magnesium phosphate, calcium phosphate, and combinations thereof. The phosphate salts are often used in aqueous form, depending on their solubility in water. (Care should be taken to ensure that the particular phosphate compound used does not result in cracking of the composite layer).

The metal oxide-zeolite composite layer can be treated with the phosphate composition by a number of techniques. Many are referenced above, e.g., painting, dipping, or spraying. In some specific embodiments, at least two phosphate treatments are employed. As described below, a first “pass” results in some degree of phosphate conversion. A second pass is usually sufficient to completely convert the oxide to the phosphate compound, resulting in a dense composite, e.g., one with a porosity of about 10% or less. (The initial porosity of the coating material is usually about 40-50%). Moreover, the porosity should be substantially “closed porosity”, i.e., a porosity that is not interconnected over the thickness of the coating. The resulting membrane material, with substantially no interconnected porosity, can be very useful for selective gas separation, as also described below.

Moreover, it should be noted that the process to form zeolite membrane structures according to embodiments of this invention is fundamentally different from many of the prior art processes. In the past, many conventional processes were directed to growing the membrane hydrothermally, and/or growing it from a substrate surface, in the general manner of some types of crystal growth. For example, a support structure could be placed in a bath that contains ingredients needed to form a zeolite structure. Under conditions of selected time and pressure, crystals of the zeolite material would nucleate and grow on the surface of the support. The crystals would increase in size, eventually forming a network, which could function as a hermetic seal, in which the zeolite particles are encased.

Another technique used in the past to form composite membranes involved dispersing zeolite particles in a polymer matrix. These structures are referred to in the art as “mixed matrix membranes.” The polymer matrix in this class of materials is selectively permeable, but generally has lower permeation rates than the zeolite materials. The addition of zeolites improves the permeability of the membrane, and can also have benefits in selectivity. A key challenge in the fabrication of mixed matrix membranes is producing structures that have good interfacial contact between the zeolite particles and the matrix. Only specific combinations of zeolite compositions and polymer matrix compositions have been found to produce membranes that have advantageous gas permeation and selectivity properties.

The membrane structure formed by the present invention is different from the structures that result from both the “hydrothermal growth” and “mixed matrix” techniques. In the present instance, the composite membrane comprises an interconnected structure of zeolite particles, with the interstitial space filled with an inorganic matrix. This structure is different from “hydrothermally grown” materials because there are at least two compositions of matter simultaneously present in the structure. The present invention also differs from the known “mixed matrix” membranes, in that the inorganic interstitial phase is not permeable to gas. Gas permeation through the membrane occurs only through the zeolite particles and through the interstitial porosity that connects them.

The inorganic metal oxide material employed in the present invention reacts only with the phosphate, so as to provide a seal or “glue” connecting the zeolite particles in a continuous structure. The zeolite particles are left un-encased, so that they can still selectively allow gas particles to pass through them, in a desired separation process. The overall structure can be described as a composite membrane that comprises a percolating, zeolite structure, interspersed within a continuous, phosphate-based cement matrix.

FIG. 2 is an enlarged, end-view perspective of a module and membrane structure similar to that shown in FIG. 1. FIG. 2 depicts the coating 24 of the zeolite composition, applied to an inside surface 22 of the membrane structure, i.e., the scaffold. As mentioned above, in other embodiments, the coating could be applied to another surface, e.g., the outside surface of the tubular structure. Those skilled in the art understand that the membrane structure is usually completed before insertion into gas separation module 10.

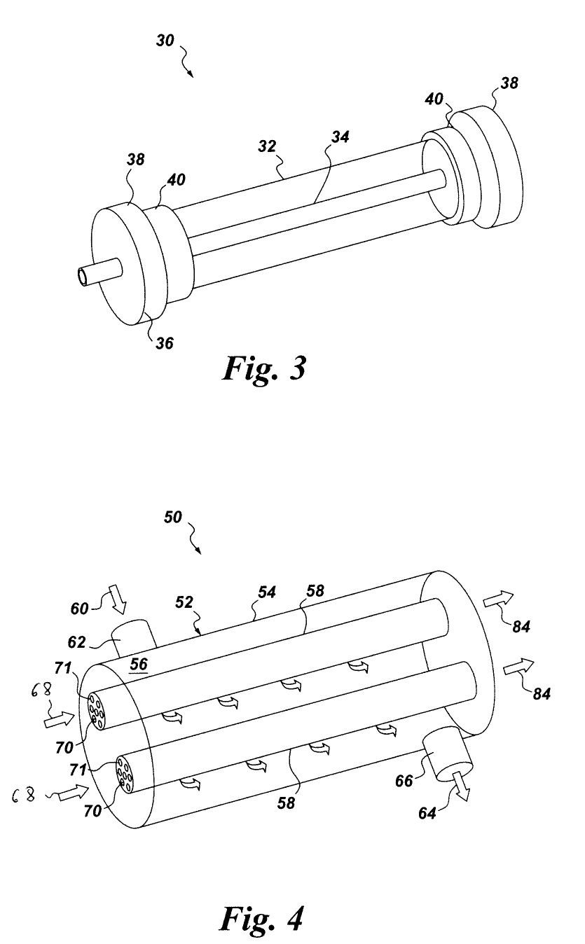

FIG. 3 is an illustration of an exemplary design for a gas separation module 30. Stainless steel housing 32, as described in other embodiments, contains one or more membrane structures 34. Each tubular structure 34 has been prepared by forming and then densifying the metal oxide-zeolite composite layer onto a suitable scaffold, as described previously. The module itself can also be provided with various types of seals or bolts, e.g., Conax™ seal 36, which can fasten plates 38 to each end. Suitable flanges 40 can be used to provide additional sealing and strength to the ends of the module. Many variations on the module structure are possible, depending in part on its intended end use.

FIG. 4 is a side-perspective view of a membrane module, according to embodiments of this invention. The figure depicts a non-limiting, exemplary gas separation module 50 for the present invention, as set forth in Patent Publication U.S. 2011/0030382 (G. Eadon et al), Feb. 10, 2011, which is incorporated herein by reference. Module 50 includes a housing 52, which can be made from a number of materials, such as stainless steel. In this embodiment, the housing is generally tubular, and includes an outer surface 54, forming a cavity 56 therein. In this instance, outer surface 54 has a circular, cross-sectional shape, with each side having approximately the same length. However, many other shapes are possible, e.g., hexagonal.

At least one ceramic membrane support 58 (also sometimes called a “membrane support structure” herein) is disposed within cavity 56 of housing 52. The membrane supports 58 are sealed in the housing 52, e.g., using polymeric gaskets (as mentioned above), with a choice of materials to fit specific needs. It should be noted that these embodiments are not limited by the number of membrane supports 58 that are disposed within the housing 52. While FIG. 4 shows a total of two membrane supports 58, the number could be considerably greater. Each membrane support contains at least one membrane structure 71, like those described above. The membrane structures 71 are usually concentric through the length of the membrane supports.

With continued reference to FIG. 4, this module is generally characterized as a “shell and tube” configuration, in which the shell is the tubular housing 52, and the “tubes” are the membrane supports 58. A first feed stream 60 can be introduced into the housing 52 through first inlet 62. The feed stream 60 contacts the outer surface of each membrane support 58, and can exit at the opposite end of the housing, as a retentate 64, through a first outlet 66. An optional sweep stream 68 can be introduced into the channels 70 of the membrane supports 58. The axially-oriented channels 70 can vary in diameter and length, and can be present in any desired number, as described in Patent Publication U.S. 2011/0030383 (A. Ku et al), Feb. 10, 2011, which is incorporated herein by reference.

With continued reference to FIG. 4, the channels 70 typically extend axially, from one end of structure 50 to an opposite end. Usually, the sweep stream 68 travels through each support 58, and exits at an opposite end of the housing 52, as the remaining sweep stream and permeate 84.

The membrane supports 58 can be fabricated with channels 70, e.g., by drilling and machining techniques. However, supports with a desired number of channels already formed therein (and having a desired diameter) can usually be obtained commercially. As described previously, the interior of the surface of each channel can serve as the scaffold, upon which the zeolite composition is applied, by a variety of coating or dipping techniques.

In the illustrated embodiment of FIG. 4, module 50 has a co-current flow configuration with two inlets and two outlets, in which the feed stream 60 and the sweep-stream 68 are introduced at the same end of the housing 52. Moreover, the two streams flow in the same direction through housing 52, and exit at the opposite end of the housing. However, it will be appreciated that module 50 can be configured in a counter-current flow configuration, in which the feed stream 60 is introduced at an opposite end of the housing 62 as the sweep stream 68, flows through the housing 52 in an opposite direction as the sweep stream 68, and exits at the opposite end of the housing 52 as the sweep stream 68.

### EXAMPLES

The example presented below is intended to be merely illustrative, and should not be construed to be any sort of limitation on the scope of the claimed invention.

35 mass % zeolite (clinoptilolite grade) and magnesium oxide (MgO) slurries were prepared in water, and milled, using 5 mm YTZ grinding media for 24 hours. The nominal particle size distribution after milling was about 2-3 microns for the zeolite material, and less than 1 micron for the MgO material. A 15 mass % medium molecular weight PVA binder solution was also prepared.

The three components were mixed according to proportions that resulted in a final coating slurry having the concentrations shown in Table 1. The nominal viscosity of the coating slurry was in the range of about 25-30 cp (LV1 spindle, Brookfield viscometer, at 20° C. and 200 rpm).

TABLE 1

| Inorganic Solids | Total Binder | Total Zeolite | Total MgO |
|---|---|---|---|
| Loading of Slurry | Concentration | Concentration | Concentration |
| (Mass %) | (Mass %) | (Mass %) | (Mass %) |
| 5.0 | 2.43 | 4.55 | 0.46 |

The scaffold used in this case was a tubular, 800 nm nominal pore size alpha-Al₂O₃ substrate (30-40% porosity), with an inner diameter of approximately 3.5 mm. The prepared slurry was applied on the inside surface of the scaffold, using a modified pressure slip casting process. The pressure applied during the 10 minute-coating step was 10 psi. The overall coating parameters were as follows:

| | | |
|---|---|---|
| Slurry flow rate | 190-210 | g/min |
| Coating back-pressure | 10 | psi |
| Coating duration | 10 | minutes |
| Drying temperature | 30° | C. |
| Drying humidity | 80% | RH |

| | |
|---|---|
| Drying duration | 48 hours (prior to sintering) |

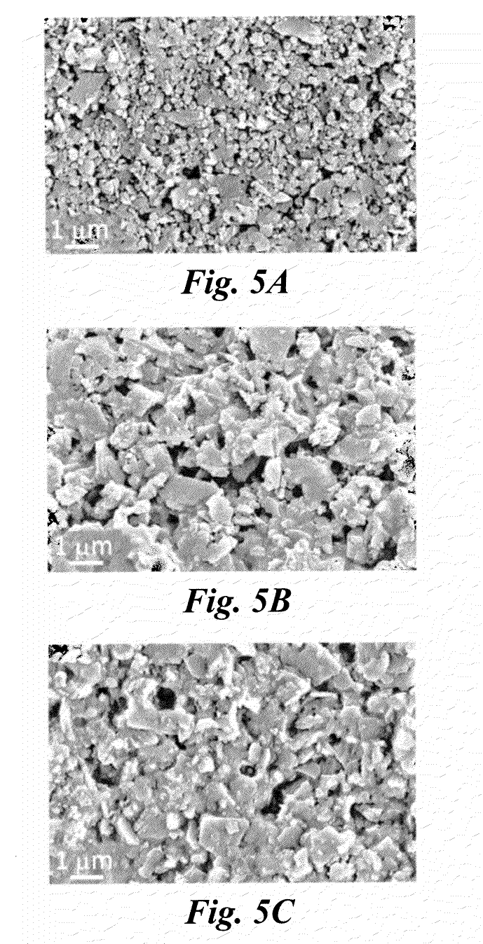

The dried tubes were sintered in air at 400° C., for 4 hours, to remove the organic binder. The final coating thickness after sintering was in the range of about 10-30 microns. FIG. 5A depicts the sintered MgO-Zeolite composite. The microstructure exhibited a bimodal particle size distribution (PSD). The smaller particles that fill the interstitial gaps are primarily MgO, while the larger particles are zeolite.

The phosphating step generally described above was then carried out as follows: 14 g of monopotassium phosphate (MKP, KH₂PO₄, potassium phosphate monobasic) was dissolved in 50 g of water. A syringe was used to inject this solution through the thickness of the MgO-zeolite composite coating. As noted previously, the MgO reacted with the phosphate solution, to form magnesium phosphate. FIG. 5B depicts the composite structure after the first phosphate treatment “pass”.

It is believed that some unreacted MgO was still present in the composite at this stage. In order to ensure 100% conversion of the MgO to magnesium phosphate, the phosphating step was repeated, resulting in the structure shown in FIG. 5C. In this particular instance, the difference in composite structure between FIGS. 5A and 5B was not particularly large, and the second phosphating step may not always be necessary.

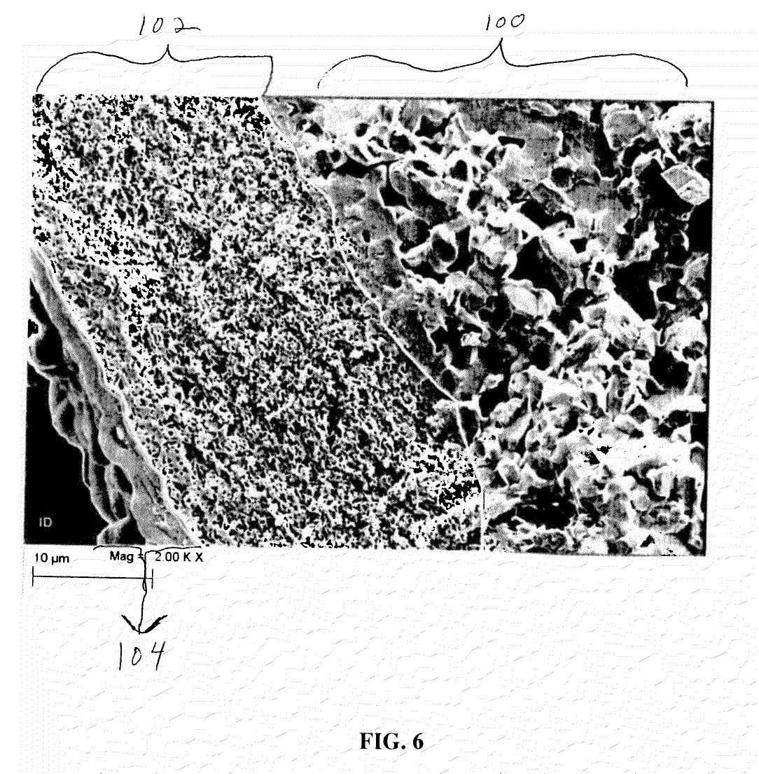

It should also be noted that the interface at which the MgO reacts with the MKP to form magnesium phosphate is somewhat limited in dimension. In other words, the reaction zone was only about 1-3 microns in surface depth, as compared to the 10-30 micron-thickness of the coating, as further described and explained in reference to FIG. 6.

FIG. 6 is an SEM image (2.00 KX magnification) for a coating structure similar to that prepared as described above, i.e., the identified coating slurry applied on a porous alumina scaffold, followed by the phosphating step (two passes). Region 100 is the alumina scaffold, while region 102 is the magnesium oxide-zeolite composite structure. Region 104 is the upper, dense layer, in which the MgO has completely reacted with the phosphate compound (MKP), to form magnesium phosphate. Region 104 is characterized by substantially “closed porosity”, i.e., a porosity that is not interconnected over the thickness of the coating. A membrane composite structure that includes such a region can be very useful for selective gas separation, as described previously.

The membrane modules prepared according to this invention can be used for a variety of purposes. One primary end use is the separation of hydrogen in a gas mixture, e.g., a mixture which is formed before, during, or after a combustion, gasification, or reforming process. Various types of power plants include operation units in which such gas mixtures are present. Non-limiting examples include the IGCC power plants described previously. These plants rely on at least one gasification unit which converts carbon-containing material (e.g., coal) into synthesis gas (syngas). (Syngas can be produced through either methane steam reforming or gasification).

As mentioned above, these power plants usually include at least the following operations: at least one gasification unit; at least one water-gas-shift reactor (e.g., for producing a gas stream rich in hydrogen and carbon dioxide); at least one membrane unit suitable for hydrogen gas separation (e.g., as part of a syngas cleanup unit); and at least one power generation unit. Power-producing systems of this type are described in a number of references, such as the previously mentioned U.S. Patent Publication 2011/0030382 (Eadon et al). Moreover, in the case of hydrogen production applications, membranes such as those described herein are often very preferred: the selective permeability to hydrogen can result in a higher-purity product.

Furthermore, the membrane structures can be used for various other processes that involve gas separation steps. Non-limiting examples include chemical production, heavy oil-upgrading, and helium enrichment from natural gas.

While this disclosure has been illustrated and described in typical embodiments, it is not intended to be limited to the details shown, since various modifications and substitutions can be made without departing in any way from the spirit of the present disclosure. All such modifications and equivalents are believed to be within the spirit and scope of the disclosure, as defined by the following claims.

What is claimed:

1. A method for fabricating a high-density zeolite membrane structure, comprising the following steps:
a) combining (i) a mineral zeolite material; (ii) at least one cement precursor; and (iii) an organic binder, with an aqueous component, to form a porous, aqueous composite zeolite composition;
b) applying a layer of the aqueous composite zeolite composition to a first surface of a scaffold comprising a porous, metal-oxide material;
c) allowing the porous layer to dry at an evaporation rate slow enough to substantially prevent the formation of coating cracks; under conditions of relatively high humidity;
d) heating the dried coating at a temperature and for a time period sufficient to substantially remove the organic binder; resulting in the formation of a metal oxide-zeolite, porous composite layer; and
e) exposing the composite layer to a phosphate composition, under conditions sufficient to reduce the porosity in the composite layer to a level of no greater than about 10%, resulting in a high-density zeolite cement composite membrane structure.

2. The method of claim 1, wherein the mineral zeolite material is selected from the group consisting of clinoptilolite, heulandite, mordenite, and combinations thereof.

3. The method of claim 1, wherein the mineral zeolite material comprises clinoptilolite.

4. The method of claim 1, wherein the mineral zeolite component comprises zeolite particles having an average particle size of up to about 45 microns.

5. The method of claim 1, wherein the cement precursor comprises at least one metal oxide.

6. The method of claim 5, wherein the metal oxide comprises magnesium oxide.

7. The method of claim 6, wherein the magnesium oxide comprises powder particles that have an average surface area of less than about 1 m²/g, as measured by BET.

8. The method of claim 1, wherein the ratio of zeolite to the cement precursor is in the range of about 1:1 to about 20:1.

9. The method of claim 1, wherein the binder is a water-soluble synthetic polymer.

10. The method of claim 9, wherein the binder is selected from the group consisting of polyvinyl alcohol, polyvinyl acetate, polyethylene glycol; and polyvinyl pyrrolidone.

11. The method of claim 1, wherein drying step (c) is carried out under a humidity level in the range of about 75% to about 100%.

12. The method of claim 1, wherein the phosphate composition is a phosphate salt selected from ammonium phosphate, diammonium phosphate, monoammonium phosphate, potassium phosphate, sodium phosphate, magnesium phosphate, calcium phosphate, and combinations thereof.

13. A gas separation module comprising a high-density zeolite cement-composite membrane structure fabricated according to claim 1.

14. A method for separating hydrogen from a fluid stream, comprising the step of contacting the fluid stream with at least one membrane structure, to preferentially transport hydrogen across the structure, wherein the membrane structure comprises a high-density zeolite phosphate-cement composite structure.

15. The method of claim 14, wherein the zeolite is clinoptilolite.

16. A composite membrane, comprising a percolating, zeolite structure, interspersed within a continuous, phosphate-based cement matrix, and disposed on a porous metal oxide support structure.

17. A power plant, comprising a gasification unit that converts carbonaceous fuel into synthesis gas; a water-gas-shift reactor in flow-communication with the gasification unit, and configured to receive the synthesis gas, to produce a gaseous product mixture comprising hydrogen and carbon dioxide; and a membrane unit in flow-communication with the water-gas-shift reactor; and capable of separating hydrogen from the gaseous product mixture, wherein the membrane unit includes at least one composite membrane structure according to claim 16.
